(19) United States
(12) Patent Application Publication
(10) Pub. No.: US 2024/0294153 A1
(43) Pub. Date: Sep. 5, 2024

(54) ELECTRONIC BRAKE SYSTEM AND SIMULATOR VALVE PROVIDED IN THE SAME

(71) Applicant: HL MANDO CORPORATION, Gyeonggi-do (KR)

(72) Inventor: Sungho Kwak, Gyeonggi-do (KR)

(21) Appl. No.: 18/219,568

(22) Filed: Jul. 7, 2023

(30) Foreign Application Priority Data
Mar. 3, 2023 (KR) 10-2023-0028377

(51) Int. Cl. B60T 8/40

(52) U.S. Cl. CPC B60T 8/409

(57) ABSTRACT

The present disclosure relates to an electronic brake system and a simulator valve provided in the same, and the electronic brake system includes a reservoir configured to store oil, a master cylinder configured to operate in conjunction with a brake pedal and generate hydraulic pressure in response to a pedal effort of the brake pedal, and the simulator valve provided between the reservoir and the master cylinder and configured to be opened so that the oil in the master cylinder flows to the reservoir when the brake pedal is pressed.

### CROSS-REFERENCE TO RELATED APPLICATIONS

This application claims benefit and priority to Korean Patent Application No. 10-2023-0028377, filed on Mar. 3, 2023, with the Korean Intellectual Property Office, the disclosure of which is incorporated herein in its entirety by reference.

### TECHNICAL FIELD

The present disclosure relates to an electronic brake system and a simulator valve provided in the same, and more particularly, to an electronic brake system and a simulator valve provided in the same, which perform a braking process in conjunction with an operation of a brake pedal operated by a driver.

### BACKGROUND

Vehicles are essentially equipped with brake systems for braking the vehicles. Recently, various types of systems for obtaining a higher, stabler braking force have been proposed.

Examples of the brake systems include an anti-lock brake system (ABS) configured to prevent a slip of a wheel during a braking process, a brake traction control system (BTCS) configured to prevent a slip of a driving wheel when a vehicle suddenly or rapidly accelerates, and an electronic stability control system (ECS) configured to stably maintain a traveling state of a vehicle by controlling a brake fluid pressure with a combination of the anti-lock brake system and the traction control.

In general, an electronic brake system includes a hydraulic pressure supply device that supplies pressure to a wheel cylinder by receiving an electrical signal related to a driver's braking intention from a pedal displacement sensor that detects a displacement of a brake pedal when the driver presses the brake pedal.

In particular, the electronic brake system includes a simulation device capable of providing the driver with a reaction force corresponding to a brake pedal effort. In this case, the simulation device is connected to an oil reservoir, and a simulator valve is installed in an oil flow path that connects the simulation device and the reservoir. The simulator valve is configured to be closed when the brake system abnormally operates. The simulator valve performs a stable braking process by allowing hydraulic pressure discharged from a master cylinder to be transmitted to a wheel cylinder.

Because the simulator valve is closed when the brake system operates abnormally, the simulator valve needs to be opened when the brake system operates normally so that the oil discharged from the master cylinder may be transferred to the reservoir.

However, in case that the driver presses the brake pedal excessively strongly to rapidly brake the vehicle, a plunger provided in the simulator valve is closed, and the simulator valve is also closed, which causes a problem in which the oil in the master cylinder is transferred to the wheel cylinder instead of the reservoir. Therefore, there is a need to improve the simulator valve to solve the problem.

### SUMMARY

The present disclosure has been made in an effort to provide an electronic brake system, which has an improved structure capable of transferring oil in a master cylinder to a reservoir by preventing a simulator valve from being closed even during a rapid braking process in which a brake pedal of the electronic brake system is deeply pressed, and a simulator valve provided in the same.

An exemplary embodiment of the present disclosure provides an electronic brake system including: a reservoir configured to store oil; a master cylinder configured to operate in conjunction with a brake pedal and generate hydraulic pressure in response to a pedal effort of the brake pedal; and a simulator valve provided between the reservoir and the master cylinder and configured to be opened so that the oil in the master cylinder flows to the reservoir when the brake pedal is pressed, in which the simulator valve includes a plunger configured to reciprocate in a longitudinal direction of the simulator valve when an electromagnetic force is applied, and in which a diameter of a hole, into which the oil is introduced from the master cylinder, is set within a predetermined diameter range in which pressure at an upper side and pressure at a lower side of the plunger based on the plunger are maintained within a predetermined pressure range.

The simulator valve may include: a valve main body unit configured to be operated by an electromagnetic force; and a seat unit coupled to any one side of the valve main body unit and configured to open or close a flow path, which is directed from the master cylinder toward the reservoir, in accordance with an operation of the valve main body unit.

The valve main body unit may include: a valve housing having therein a through-portion formed in a longitudinal direction; a valve core inserted into the valve housing at one side of the valve housing; and an armature provided in the valve housing and configured to reciprocate in a longitudinal direction of the valve housing when the electromagnetic force is applied, and the plunger may be coupled to the other side of the valve housing and reciprocate in the longitudinal direction of the valve housing in conjunction with the armature.

The plunger may include: a plunger body having one side positioned inside the valve housing, and the other side positioned outside the valve housing; and a plunger flange extending in a radial direction at one side of the plunger body, and the plunger body may have a first inclined surface formed to connect a lower surface and a lateral surface thereof.

The seat unit may include: a seat housing coupled to the other side of the valve housing and having first and second flow path holes so that the oil flows from the master cylinder to the reservoir; and a seat block provided in the seat housing and having an orifice formed at a center of the seat block and formed through the seat block in a longitudinal direction.

The seat block may have a second inclined surface formed to connect an inner peripheral surface of the orifice and an upper surface of the seat block.

The second flow path hole may be a hole formed to communicate with the reservoir, and the second flow path hole may be formed at a lower side of the seat housing.

The first flow path hole may be formed such that a central axis passing through a center of the first flow path hole is positioned above the upper surface of the seat block.

An imaginary line passing through a center of the first flow path hole may be in contact with the first inclined surface, and the oil introduced through the first flow path hole may collide with the first inclined surface such that a flow direction is changed to a direction directed toward the orifice.

Before the plunger moves upward, the first inclined surface and the second inclined surface may be in close contact with each other, and a portion between the first flow path hole and the second flow path hole may be blocked.

Another exemplary embodiment of the present disclosure provides a simulator valve for an electronic brake system, which is provided between a reservoir and a master cylinder, the simulator valve including: a valve main body unit including a plunger configured to reciprocate in a longitudinal direction when an electromagnetic force is applied; and a seat unit coupled to any one side of the valve main body unit and configured to open or close a flow path in accordance with an operation of the valve main body unit so that oil flows from the master cylinder toward the reservoir, in which the seat unit is configured such that a size of a hole, which is formed so that the oil is introduced from the master cylinder, is set within a predetermined diameter range in which pressure at an upper side and pressure at a lower side of the plunger based on the plunger are maintained within a predetermined pressure range.

The valve main body unit may include: a valve housing having therein a through-portion formed in a longitudinal direction; a valve core inserted into the valve housing at one side of the valve housing; and an armature provided in the valve housing and configured to reciprocate in a longitudinal direction of the valve housing when the electromagnetic force is applied, and the plunger may be coupled to the other side of the valve housing and reciprocate in the longitudinal direction of the valve housing in conjunction with the armature.

The plunger may include: a plunger body having one side positioned inside the valve housing, and the other side positioned outside the valve housing; and a plunger flange extending in a radial direction at one side of the plunger body, and the plunger body may have a first inclined surface formed to connect a lower surface and a lateral surface thereof.

The seat unit may include: a seat housing coupled to the other side of the valve housing and having first and second flow path holes so that the oil flows from the master cylinder to the reservoir; and a seat block provided in the seat housing and having an orifice formed at a center of the seat block and formed through the seat block in a longitudinal direction.

The seat block may have a second inclined surface formed to connect an inner peripheral surface of the orifice and an upper surface of the seat block.

The predetermined diameter range may be smaller than a size in diameter of an imaginary circle that adjoins the first inclined surface and the second inclined surface.

The first flow path hole may be a hole into which the oil is introduced from the master cylinder, the first flow path hole may be formed in a lateral surface of the seat housing, the second flow path hole may be a hole formed to communicate with the reservoir, and the second flow path hole may be formed at a lower side of the seat housing.

The first flow path hole may be formed such that a central axis passing through a center of the first flow path hole is positioned above the upper surface of the seat block.

An imaginary line passing through a center of the first flow path hole may be in contact with the first inclined surface, and the oil introduced through the first flow path hole may collide with the first inclined surface such that a flow direction is changed to a direction directed toward the orifice.

Before the plunger moves upward, the first inclined surface and the second inclined surface may be in close contact with each other, and a portion between the first flow path hole and the second flow path hole may be blocked.

Other detailed matters of the exemplary embodiment are included in the detailed description and the drawings.

The electronic brake system and the simulator valve provided in the same according to the present disclosure show the following effects.

First, only the reduction in size of the hole (first flow path hole), which is formed in the seat housing to introduce the oil from the master cylinder to the simulator valve, may prevent the plunger from being closed when the driver presses the brake pedal deeply to rapidly brake the vehicle.

In particular, the size of the first flow path hole is adjusted within a predetermined size in diameter so that the pressure at the upper side and the pressure at the lower side of the plunger are maintained within the predetermined pressure range, which may prevent a problem of a change in pedal feel or a delay of pedal returning.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a block diagram illustrating a configuration of an electronic brake system according to an embodiment of the present disclosure.

FIG. 2 is a cross-sectional view illustrating a simulator valve provided in the electronic brake system according to the embodiment of the present disclosure.

FIGS. 3 and 4 are cross-sectional views illustrating an operating state of the simulator valve in FIG. 1.

FIG. 5 is a partially enlarged cross-sectional view of part “A” in FIG. 4.

FIGS. 6A and 6B are an analysis view illustrating pressure states in the simulator valve in FIG. 1 and a simulator valve in the related art.

### DETAILED DESCRIPTION

In the following detailed description, reference is made to the accompanying drawing, which forms a part hereof. The illustrative embodiments described in the detailed description, drawing, and claims are not meant to be limiting. Other embodiments may be utilized, and other changes may be made, without departing from the spirit or scope of the subject matter presented here.

Hereinafter, embodiments of the present disclosure will be described in detail with reference to the accompanying drawings so that those with ordinary skill in the art to which the present disclosure pertains may easily carry out the embodiments. The present disclosure may be implemented in various different ways, and is not limited to the embodiments described herein.

It is noted that the drawings are schematic and are not illustrated based on actual scales. Relative dimensions and proportions of parts illustrated in the drawings are exaggerated or reduced in size for the purpose of clarity and convenience in the drawings, and any dimension is just illustrative but not restrictive. The same reference numerals designate the same structures, elements or components illustrated in two or more drawings in order to exhibit similar characteristics.

Embodiments of the present disclosure illustrate ideal embodiments of the present disclosure in detail. As a result, various modifications of the drawings are expected. Therefore, the embodiments are not limited to specific forms in regions illustrated in the drawings, and for example, include modifications of forms by the manufacture thereof.

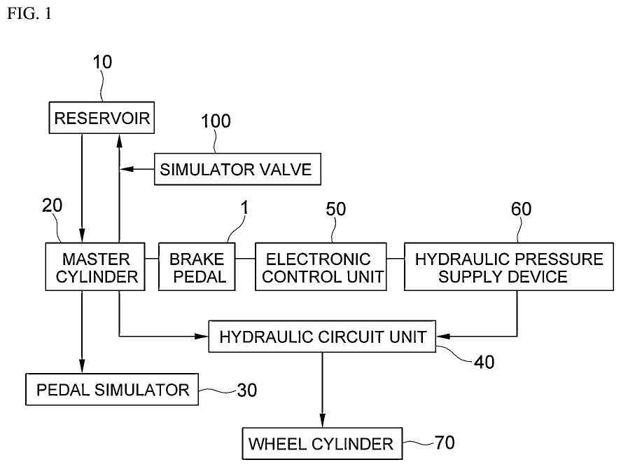

Hereinafter, an electronic brake system and a simulator valve provided in the same according to the present disclosure will be specifically described with reference to FIGS. 1 to 6.

An electronic brake system according to an embodiment of the present disclosure includes a reservoir 10, a master cylinder 20, a pedal simulator 30, a hydraulic circuit unit 40, an electronic control unit 50, a hydraulic pressure supply device 60, and a simulator valve 100.

The reservoir 10 stores oil that is a working fluid. The oil may be transferred from the reservoir 10 to the other locations or flow to the reservoir 10 from the other locations.

The master cylinder 20 receives the oil from the reservoir 10. The master cylinder 20 uses the supplied oil to generate hydraulic pressure to be supplied to the hydraulic circuit unit 40. Specifically, when a driver operates a brake pedal 1, the master cylinder 20 is pressed, and the hydraulic pressure is generated.

The pedal simulator 30 receives the hydraulic pressure generated by the master cylinder 20. The pedal simulator 30 uses the hydraulic pressure generated by the master cylinder 20 and provide the driver with a reaction force related to a pedal effort of the brake pedal 1. Therefore, the driver may precisely operate the brake pedal 1 and precisely adjust a force for braking a vehicle.

The hydraulic circuit unit 40 serves to distribute and transmit the hydraulic pressure, which is generated by the master cylinder 20, to a wheel cylinder 70.

Meanwhile, in an emergency situation such as a situation in which electric power is not supplied to the entire system, the hydraulic pressure of the master cylinder 30 may be transmitted directly to the wheel cylinder 70, thereby braking the vehicle.

The electronic control unit 50 receives an electrical signal in response to a detected displacement of the brake pedal 1. The electronic control unit 50 outputs a signal to operate the hydraulic pressure supply device 60 in response to the transmitted electrical signal.

The hydraulic pressure supply device 60 receives the oil from the reservoir 10 and generates the hydraulic pressure. The hydraulic pressure supply device 60 supplies the generated hydraulic pressure to the wheel cylinder 70 through the hydraulic circuit unit 40.

The simulator valve 100 is provided between the reservoir 10 and the master cylinder 20. When the brake pedal 1 is pressed, the simulator valve 100 is opened so that the oil in the master cylinder 20 may flow to the reservoir 10.

The simulator valve 100 includes a valve main body unit 110 and a seat unit 120.

The valve main body unit 110 is operated by an electromagnetic force to open the simulator valve 100. The valve main body unit 110 includes a valve housing 111, a valve core 112, an armature 113, and a plunger 114.

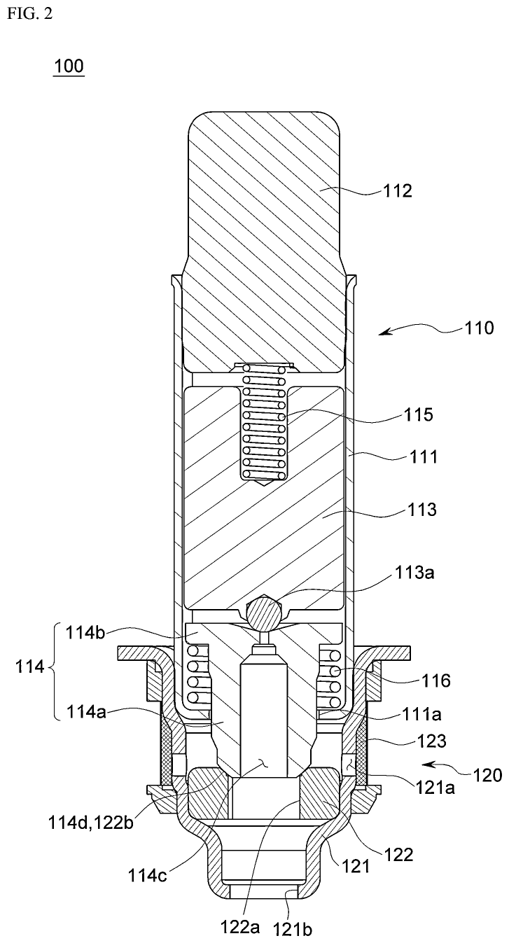

The valve housing 111 has therein a through-portion formed in a longitudinal direction. With reference to FIG. 2, an upper side of the valve housing 111 is open and has an internal space, and a lower side of the valve housing 111 has a through-hole 111a.

The valve core 112 is provided at one side (upper side) of the valve housing 111 and inserted into the valve housing 111. The valve core 112 serves to cover the upper side of the valve housing 111.

The armature 113 is provided in the valve housing 111. The armature 113 is reciprocated by an electromagnetic force in the longitudinal direction of the valve housing 111. In the present embodiment, an example in which the armature 113 moves upward or downward will be described with reference to the drawings.

A first elastic member 115 is provided between the valve core 112 and the armature 113. The first elastic member 115 provides a restoring force so that the first elastic member 115 is compressed when the simulator valve 100 is opened and the armature 113 moves upward, and the first elastic member 115 restores the armature 113 when the simulator valve 100 is closed.

The plunger is coupled to the other side of the valve housing 111. Specifically, the plunger 114 passes through the through-hole 111a. A part of the plunger 114 is positioned in the valve housing 111, and the remaining part of the plunger 114 is coupled to protrude to the outside of the other side (lower side) of the valve housing 111.

Like the armature 113, the plunger 114 also moves upward or downward. The plunger 114 is moved upward or downward by a difference between pressure at an upper side and pressure at a lower side based on the plunger 114. This configuration will be more specifically described below.

The plunger 114 includes a plunger body 114a and a plunger flange 114b.

The plunger body 114a is formed in a shape similar to a cylindrical shape and has therein a hollow portion 141c formed in the longitudinal direction. An armature ball 113a is provided at a lower side of the armature 113. An upper side of the hollow portion 141c is covered by the armature ball 113a.

When the plunger 114 is provided in the valve housing 111, the plunger body 114a is provided to pass through the through-hole 111a. When the plunger body 114a passes through the through-hole 111a, the plunger body 114a and the through-hole 111a are finely spaced apart from each other. Therefore, the oil introduced from the master cylinder 20 flows between the plunger body 114a and the through-hole 111a and flows into the valve housing 111.

A first inclined surface 114d is formed between a lower surface (not illustrated) and a lateral surface (not illustrated) of the plunger body 114a and connects the lower surface and the lateral surface. The first inclined surface 114d is in close contact with a seat block 112 to be described below. This configuration will be specifically described below.

The plunger flange 114b extends in a radial direction from one side (upper side) of the plunger body 114a. The plunger flange 114b further protrudes than an outer peripheral surface of the plunger body 114a, which may prevent the plunger 114 from being withdrawn through the through-hole 111a.

The valve main body unit 110 further includes a second elastic member 116. The second elastic member 116 is provided in the valve housing 111 while surrounding the plunger 114. Specifically, the second elastic member 116 surrounds the plunger body 114a. The plunger flange 114b is caught by the second elastic member 116.

The second elastic member 116 supports the plunger 114 when the plunger 114 moves downward after the upward movement. The impact may be absorbed when the plunger 114 is moved by the elastic force of the second elastic member 116 and comes into contact with the second elastic member 116.

The seat unit 120 is coupled to any one side of the valve main body unit 110. In the present embodiment, the seat unit 120 is connected to a lower side of the valve main body unit 110, as illustrated in FIG. 1.

The seat unit 120 includes a seat housing 121, a seat block 122, and a filter member 123.

The seat housing 121 is coupled to the lower side of the valve housing 111. The seat housing 121 is open at an upper side thereof and has a space formed therein. The lower side of the valve main body unit 110 is inserted into the open upper side of the seat housing 121. The lower side of the valve main body unit 110 is positioned in the internal space of the seat housing 121. The open upper side of the seat housing 121 is covered by the valve main body unit 110 inserted into the seat housing 121.

The seat housing 121 has a first flow path hole 121a and a second flow path hole 121b so that the oil flows from the master cylinder 20 to the reservoir 10.

The first flow path hole 121a is a hole into which the oil is introduced from the master cylinder 20. The first flow path hole 121a is formed in a lateral surface of the seat housing 121. The first flow path hole 121a is provided as a plurality of first flow path holes 121a spaced apart from one another at a preset angle in a circumferential direction of the seat housing 121.

The second flow path hole 121b is a hole formed to communicate with the reservoir 10. The second flow path hole 121b is formed at a lower side of the seat housing 121.

The seat block 122 is provided in the seat housing 121. An orifice 122a is formed at a center of the seat block 122 and formed through the seat block 122 in the longitudinal direction.

The seat block 122 has a second inclined surface 122b that connects an inner peripheral surface of the orifice 122a and an upper surface of the seat block 122. Specifically, when the plunger 114 moves downward and comes into close contact with the seat block 122, the first inclined surface 114d and the second inclined surface 122b come into close contact with each other.

When the simulator valve 100 is in a basic state, i.e., when the simulator valve 100 is in a closed state, the first inclined surface 114d of the plunger 114 and the second inclined surface 122b of the seat block 122 are in close contact with each other. Therefore, the orifice 122a of the seat block 122 is in a closed state.

When the brake pedal is pressed, the valve main body unit 110 is operated by the electromagnetic force, and the plunger 114 is moved upward. In this case, the orifice 122a of the seat block 122 is opened, and the first flow path hole 121a and the second flow path hole 121b communicate with each other.

A size in diameter of the first flow path hole 121a is set within a predetermined diameter range in which the pressure at the upper side and the pressure at the lower side based on the plunger 114 is maintained within a predetermined pressure range. In particular, the predetermined diameter range is smaller than a size in diameter D1 of an imaginary circle defined as the first inclined surface 114d of the plunger 114 and the second inclined surface 122b of the seat block 122 adjoin each other. That is, a size in diameter D2 of the first flow path hole 121a is smaller than the size in diameter D1 of the imaginary circle defined as the first inclined surface 114d and the second inclined surface 122b adjoin each other.

In the related art, there is a problem in that the plunger is moved downward by a force generated by a flow of the oil when the oil flows through the first flow path hole because of the difference between the pressure at the upper side and the pressure at the lower side of the plunger. In contrast, when the size in diameter D2 of the first flow path hole 121a is smaller than the size in diameter D1 of the imaginary circle as described above, the difference between the pressure at the upper side and the pressure at the lower side of the plunger 114 is maintained within the predetermined pressure range, which may solve the problem in which the plunger 114 moves downward.

In addition, the first flow path hole 121a is formed such that a central axis passing through a center of the first flow path hole 121a is positioned above the upper surface of the seat block 122. Further, an imaginary horizontal line extending from the center of the first flow path hole 121a adjoins the first inclined surface 114d of the plunger 144.

With the above-mentioned structure, the oil introduced through the first flow path hole 121a collides with the first inclined surface 114d of the plunger 114, such that a flow direction is changed to a direction directed toward the orifice 122a. Further, when the oil collides with the first inclined surface 114d, the oil exhibits a force that moves the plunger 114 upward. Therefore, it is possible to prevent the plunger 114 from being moved downward and prevent the simulator valve 100 from being closed.

The filter member 123 is provided outside the seat housing 121. Specifically, the seat housing 121 is inserted into the filter member 123, and an inner surface of the filter member 123 and an outer surface of the seat housing 121 are in close contact with each other. The filter member 123 prevents foreign substances from being introduced through the first inflow hole 121a.

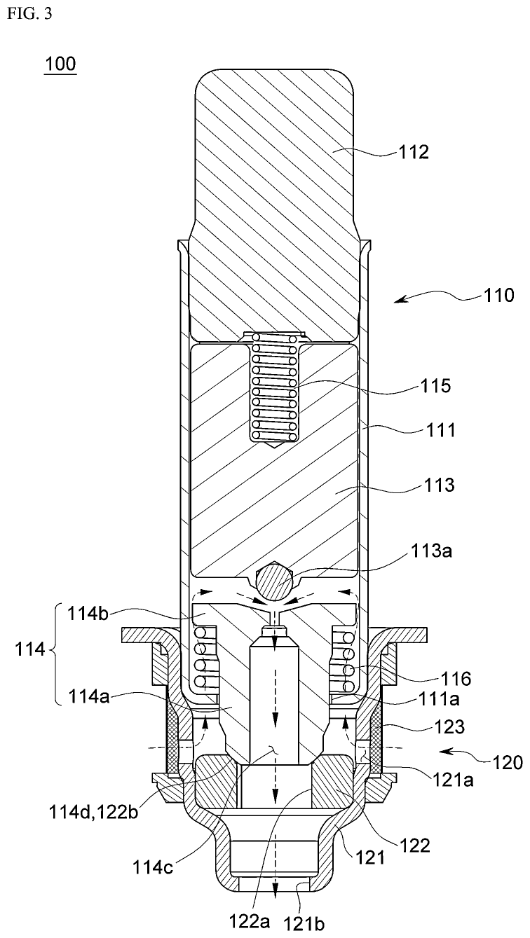

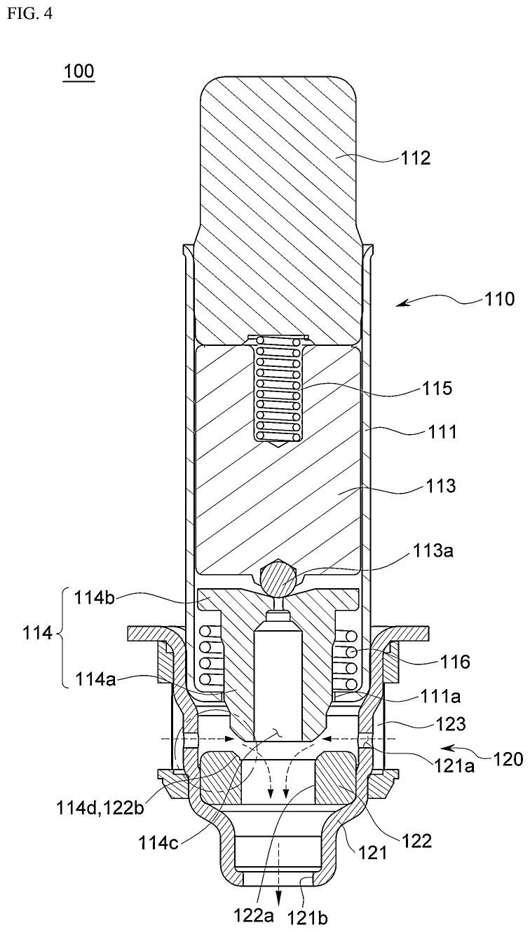

Hereinafter, a process of operating the simulator valve 100 will be described with reference to FIGS. 3 and 4.

When the driver presses the brake pedal to brake the vehicle while the vehicle travels, the oil in the master cylinder 20 is introduced through the first inflow hole 121a, and the electromagnetic force is applied to the simulator valve 100.

In this case, the armature 113 is moved upward by the applied electromagnetic force. The first elastic member 115, which connects the valve core 111 and the armature 113, is compressed.

The oil introduced through the first inflow hole 121a flows into the valve housing 111 through a portion between the valve housing 111 and the plunger 114.

When the armature 113 moves upward, the closed hollow portion 114c of the plunger 114 is opened, and the oil introduced into the valve housing 111 flows along the hollow portion 114c. The pressure at the upper side of the plunger 114, which has been instantaneously increased, decreases, such that the difference between the pressure at the upper side and the pressure at the lower side of the plunger 114 is eliminated, and the plunger 114 also moves upward.

When the plunger 114 moves upward, the hollow portion 114c of the plunger 114 is covered by the armature ball 113a, and the orifice 122a of the seat block 122, which has been covered by the plunger 114, is opened. The oil introduced through the first inflow hole 121a passes through the orifice 122a and flows to the reservoir 10 through the second flow path hole 121b.

The pressure at the upper side and the pressure at the lower side of the plunger 114 are maintained within the predetermined pressure range by the oil introduced through the first flow path hole 121a, which prevents the plunger 114 from moving downward.

In particular, the oil introduced through the first flow path hole 121a collides with the first inclined surface 114d of the plunger 114 such that the flow direction is changed to the direction directed toward the orifice 122a. In this case, the oil introduced through the first flow path hole 121a may exhibit the force that moves the plunger 114 upward, which may prevent the plunger 114 from moving downward.

Therefore, the plunger 114 is kept at a raised position until the vehicle travels again. In particular, even in case that the driver presses the brake pedal deeply, the oil is introduced through the first flow path hole 121a only to a degree to which the pressure at the upper side and the pressure at the lower side of the plunger 114 are maintained within the predetermined pressure range. Therefore, it is possible to prevent the plunger 114 from being moved downward and prevent the simulator valve 100 from being closed.

When the driver steps off the brake pedal 1, the electromagnetic force, which has been applied to the simulator valve 100, is eliminated, and the armature 113 and the plunger 114 move downward. In this case, the downward movement is stopped as the plunger flange 114b adjoins the second elastic member 116.

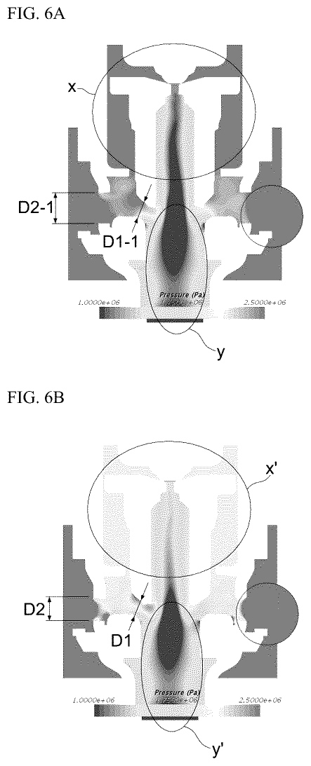

FIG. 6 is an analysis view related to an experiment performed to determine pressure states of the simulator valve according to the embodiment of the present disclosure and a simulator valve in the related art.

In the case of the simulator valve in the related art, a size of a hole, into which oil is introduced from a master cylinder, is set without considering pressure at an upper side and pressure at a lower side of the plunger. For example, in the case of a simulator valve in the related art, a size in diameter D2-1 of the hole, into which the oil is introduced from the master cylinder, is larger than a size in diameter D1-1 of an imaginary circle defined as a plunger and a seat adjoin each other.

Therefore, as illustrated in FIG. 6A, it can be seen that an imbalanced state is made in which there is a great difference between pressure x at the upper side and pressure y at the lower side of the plunger when the oil is introduced into the simulator valve from the master cylinder and the simulator valve is opened as the driver presses the brake pedal.

In contrast, in the case of the simulator valve according to the embodiment of the present disclosure described above, the size of the first flow path hole, into which the oil is introduced from the master cylinder, is set in consideration of the pressure at the upper side and the pressure at the lower side of the plunger. The size of the first flow path hole is set within a predetermined size in diameter in which the pressure at the upper side and the pressure at the lower side of the plunger are maintained within the predetermined pressure range. In particular, the size of the first flow path hole is smaller than the size in diameter of the imaginary circle defined as the plunger and the seat adjoin each other.

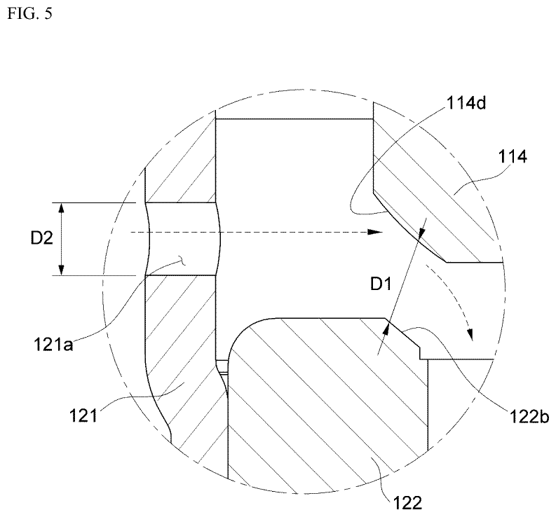

Therefore, as illustrated in FIG. 5B, it can be seen that a uniform pressure state is maintained in which pressure x′ at the upper side and pressure y′ at the lower side of the plunger are within the predetermined pressure range when the oil is introduced into the first inflow hole and the simulator valve is opened as the driver presses the brake pedal.

While the embodiments of the present disclosure have been described with reference to the accompanying drawings, those skilled in the art will understand that the present disclosure may be carried out in any other specific form without changing the technical spirit or an essential feature thereof.

Accordingly, it should be understood that the aforementioned embodiments are described for illustration in all aspects and is not limited, and the scope of the present disclosure shall be represented by the claims to be described below, and it should be construed that all of the changes or modified forms induced from the meaning and the scope of the claims, and an equivalent concept thereto are included in the scope of the present disclosure.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. An electronic brake system comprising:
a reservoir configured to store oil;
a master cylinder configured to operate in conjunction with a brake pedal and generate hydraulic pressure in response to a pedal effort of the brake pedal; and
a simulator valve provided between the reservoir and the master cylinder and configured to be opened so that the oil in the master cylinder flows to the reservoir when the brake pedal is pressed,
wherein the simulator valve comprises a plunger configured to reciprocate in a longitudinal direction of the simulator valve when an electromagnetic force is applied, and
wherein a diameter of a hole, into which the oil is introduced from the master cylinder, is set within a predetermined diameter range in which pressure at an upper side and pressure at a lower side of the plunger based on the plunger are maintained within a predetermined pressure range.

2. The electronic brake system of claim 1, wherein the simulator valve comprises:
a valve main body unit configured to be operated by an electromagnetic force; and
a seat unit coupled to any one side of the valve main body unit and configured to open or close a flow path, which is directed from the master cylinder toward the reservoir, in accordance with an operation of the valve main body unit.

3. The electronic brake system of claim 2, wherein the valve main body unit comprises:
a valve housing having therein a through-portion formed in a longitudinal direction;
a valve core inserted into the valve housing at one side of the valve housing; and
an armature provided in the valve housing and configured to reciprocate in a longitudinal direction of the valve housing when the electromagnetic force is applied, and
wherein the plunger is coupled to the other side of the valve housing and reciprocates in the longitudinal direction of the valve housing in conjunction with the armature.

4. The electronic brake system of claim 1, wherein the plunger comprises:
a plunger body having one side positioned inside the valve housing, and the other side positioned outside the valve housing; and
a plunger flange extending in a radial direction at one side of the plunger body, and
wherein the plunger body has a first inclined surface formed to connect a lower surface and a lateral surface thereof.

5. The electronic brake system of claim 2, wherein the seat unit comprises:
a seat housing coupled to the other side of the valve housing and having first and second flow path holes so that the oil flows from the master cylinder to the reservoir; and
a seat block provided in the seat housing and having an orifice formed at a center of the seat block and formed through the seat block in a longitudinal direction.

6. The electronic brake system of claim 5, wherein the seat block has a second inclined surface formed to connect an inner peripheral surface of the orifice and an upper surface of the seat block.

7. The electronic brake system of claim 6, wherein the second flow path hole is a hole formed to communicate with the reservoir, and the second flow path hole is formed at a lower side of the seat housing.

8. The electronic brake system of claim 6, wherein the first flow path hole is formed such that a central axis passing through a center of the first flow path hole is positioned above the upper surface of the seat block.

9. The electronic brake system of claim 6, wherein an imaginary line passing through a center of the first flow path hole is in contact with the first inclined surface, and the oil introduced through the first flow path hole collides with the first inclined surface such that a flow direction is changed to a direction directed toward the orifice.

10. The electronic brake system of claim 6, wherein before the plunger moves upward, the first inclined surface and the second inclined surface are in close contact with each other, and a portion between the first flow path hole and the second flow path hole is blocked.

11. A simulator valve for an electronic brake system, which is provided between a reservoir and a master cylinder, the simulator valve comprising:
a valve main body unit including a plunger configured to reciprocate in a longitudinal direction when an electromagnetic force is applied; and
a seat unit coupled to any one side of the valve main body unit and configured to open or close a flow path in accordance with an operation of the valve main body unit so that oil flows from the master cylinder toward the reservoir,
wherein the seat unit is configured such that a size of a hole, which is formed so that the oil is introduced from the master cylinder, is set within a predetermined diameter range in which pressure at an upper side and pressure at a lower side of the plunger based on the plunger are maintained within a predetermined pressure range.

12. The simulator valve of claim 11, wherein the valve main body unit comprises:
a valve housing having therein a through-portion formed in a longitudinal direction;
a valve core inserted into the valve housing at one side of the valve housing; and
an armature provided in the valve housing and configured to reciprocate in a longitudinal direction of the valve housing when the electromagnetic force is applied, and
wherein the plunger is coupled to the other side of the valve housing and reciprocates in the longitudinal direction of the valve housing in conjunction with the armature.

13. The simulator valve of claim 12, wherein the plunger comprises:
a plunger body having one side positioned inside the valve housing, and the other side positioned outside the valve housing; and
a plunger flange extending in a radial direction at one side of the plunger body, and
wherein the plunger body has a first inclined surface formed to connect a lower surface and a lateral surface thereof.

14. The simulator valve of claim 13, wherein the seat unit comprises:
a seat housing coupled to the other side of the valve housing and having first and second flow path holes so that the oil flows from the master cylinder to the reservoir; and
a seat block provided in the seat housing and having an orifice formed at a center of the seat block and formed through the seat block in a longitudinal direction.

15. The simulator valve of claim 14, wherein the seat block has a second inclined surface formed to connect an inner peripheral surface of the orifice and an upper surface of the seat block.

16. The simulator valve of claim 15, wherein the predetermined diameter range is smaller than a size in diameter of an imaginary circle that adjoins the first inclined surface and the second inclined surface.

17. The simulator valve of claim 16, wherein the first flow path hole is a hole into which the oil is introduced from the master cylinder, the first flow path hole is formed in a lateral surface of the seat housing, the second flow path hole is a hole formed to communicate with the reservoir, and the second flow path hole is formed at a lower side of the seat housing.

18. The simulator valve of claim 14, wherein the first flow path hole is formed such that a central axis passing through a center of the first flow path hole is positioned above the upper surface of the seat block.

19. The simulator valve of claim 18, wherein an imaginary line passing through a center of the first flow path hole is in contact with the first inclined surface, and the oil introduced through the first flow path hole collides with the first inclined surface such that a flow direction is changed to a direction directed toward the orifice.

20. The simulator valve of claim 16, wherein before the plunger moves upward, the first inclined surface and the second inclined surface are in close contact with each other, and a portion between the first flow path hole and the second flow path hole is blocked.
